(19) United States
(12) Patent Application Publication
(10) Pub. No.: US 2006/0164014 A1
(43) Pub. Date: Jul. 27, 2006

(54) Single end halogen incandescent bulb

(76) Inventors: Jack Baldrige, Hammondsport, NY (US); Mark Morrell, Bath, NY (US)

Correspondence Address: PHILIPS INTELLECTUAL PROPERTY & STANDARDS, P.O. BOX 3001, BRIARCLIFF MANOR, NY, 10510, US

(21) Appl. No.: 10/562,286

(22) PCT Filed: Jun. 21, 2004
(86) PCT No.: PCT/IB04/50951

§ 371 Date: Dec. 22, 2005

Related U.S. Application Data
(60) Provisional application No. 60/482,708, filed on Jun. 27, 2003.

(51) Int. Cl. H01J 61/36

(52) U.S. Cl. 313/623; 313/628

(57) ABSTRACT

A single end incandescent halogen bulb has an envelope (112) having a sealed cavity (114) containing a halide material, a pich or press seal (110) at one end, and a coiled wire filament (100) disposed in the sealed cavity (114). Filament legs (102, 104) comprise portions of the coiled wire filament (100) that have been drawn out straight so as to have a diameter which is approximately the same as a diameter of a wire from which filament (100) is formed. A first current supply (106) wire extends through the press seal (110) into the sealed cavity. This first wire (106) has a first clamp (118) formed at a terminal end thereof. The first clamp (118) clamps a first filament (102) leg to establish a first electrical connection and suspend the filament (100) in the sealed cavity (114). A second current supply wire (108) extends into and terminates within the press seal (110). This second wire (108) has a second clamp (116) which clamps a second filament leg (104) to establish a second electrical connection. The second clamp (116) is enclosed in the press seal (110).

The present invention relates to an incandescent halogen bulb having a light transmitting envelope which encloses a sealed cavity with a pinch or press seal at one end. A coiled filament is disposed with the sealed cavity and connected with a pair of lead wires. More particularly, the invention relates to a single end incandescent halogen bulb having a filament wherein both ends of the coil are pulled out and respectively clamped to a pair of lead wires.

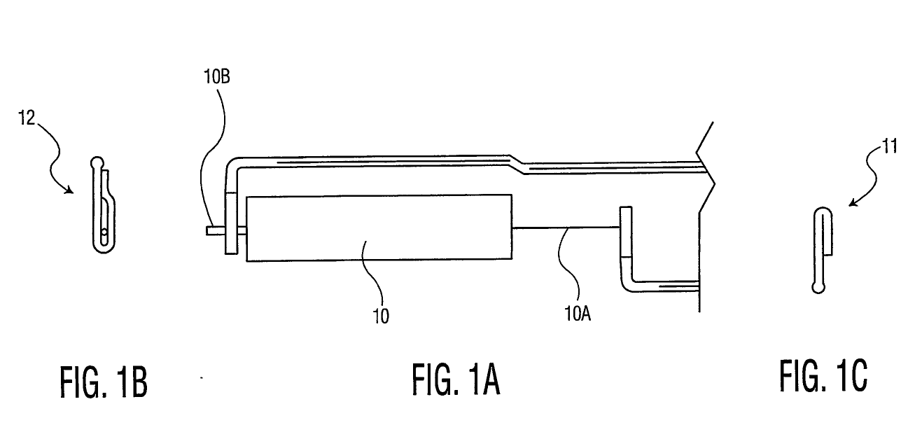

FIGS. 1A-1C show a previously proposed filament arrangement wherein one end of the coiled filament is pulled out straight and clamped to a current supply wire through a flattened clamp, while at the other end of the coil is, while still coiled per se, connected to the a second current supply wire via a standard clamp arrangement.

In the drawings:

FIG. 1A is a side view of a previously proposed filament arrangement

FIG. 1B is a front end view showing the manner in which one end of a coiled portion of a filament depicted in FIG. 1A, is clamped to a supply wire.

FIG. 1C is a rear end view showing the manner in which a second end of a coiled portion of a filament of the arrangement depicted in FIG. 1A, is clamped to a supply wire.

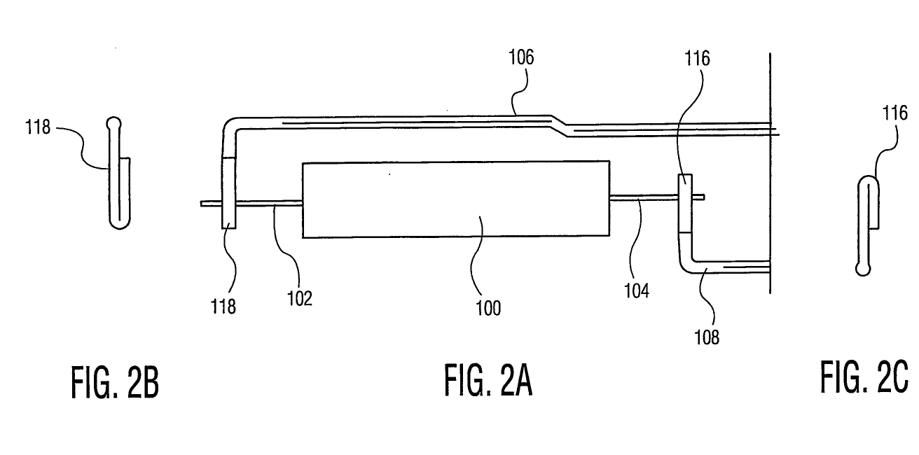

FIG. 2A is a side view showing an exemplary embodiment of the invention

FIG. 2B is a front end view showing the manner in which one end of a coiled filament depicted in FIG. 2A, which has been pulled out, is to a supply wire.

FIG. 2C is a rear end view showing the manner in which a second end of the coiled filament depicted in FIG. 2A, is also pulled out and clamped to a supply wire.

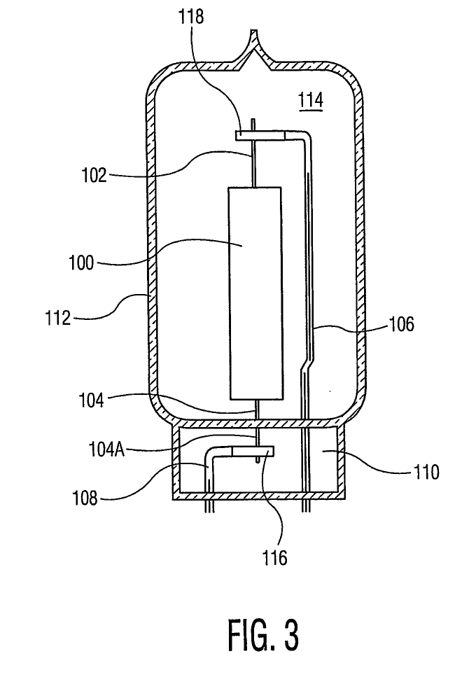

FIG. 3 shows the arrangement of FIG. 2A disposed in a sealed envelope.

As shown in FIGS. 2A-2C and 3, both ends of the coiled filament 100 (shown as an elongate rectangle for the sake of illustration) are pulled out so as to be essentially straight and to form first and second filament legs 102, 104. These filament legs 102, 104 have diameters which are approximately those of the wire from which the filament 100 is formed, and are clamped to first and second current supply wires 106, 108. As shown, the first current supply wire 106 passes through the pinch or press seal 110 formed at the bottom of the hard-glass envelope 112, and enters the cavity 114 which is defined in the envelope 112. In this embodiment, the cavity 112 is filled with a halogen compound and an inert gas and the filament 100 is made of tungsten wire.

The second current supply wire is shorter than the first, and is arranged to terminate in the press seal 110. The second of the filament legs 104 is arranged to extend into the press seal 110 and to be clamped to the second current supply wire by the clamp 116.

This arrangement has the advantages that the first filament leg 102, because it is pulled out straight it provides better support for the filament coil 100 than in the instance a portion of the coiled filament is clamped in the manner shown in FIG. 1B. That is to say, as the length of filament which is clamped in the manner shown in FIG. 1B, is still coiled per se, it tends to act as a spring and can extend and contract in the manner similar to a “slinky®” spring. With the embodiment of the invention, the first filament leg 102 material length is shorter and smaller effective diameter. It expands less for the same leg length and temperature, and moreover provides improved mechanical support for the main body of the filament 100.

In addition, the clamp 118 which is formed at the upper end of the first current supply wire 106, can be flattened with a force which is not applicable with the arrangement shown in FIGS. 1A and 1B. That is to say, with this embodiment there is no fear of crushing and breaking the filament and a clamping force can be applied which will assuredly provide a good electrical connection.

The lower filament leg 104 is, as noted above, clamped to the second current supply wire by a clamp 116. This clamp is, as shown in FIG. 3, buried in (sealed within) the press seal 110. The portion of the lower filament leg 104A which is buried in the press 110 along with the clamp 116, acts as a redundant series element, supporting the end of life action of filament leg 104A to assure passive extension of the end-of-life arcing when it disintegrates.

One method of producing the above arrangement comprises drawing the ends of the coiled wire filament 100 out straight to form the first and second filament legs 102, 104 which have diameters which are approximately the same as diameter of the wire from which the coiled filament is formed. This can be followed (not necessarily in the listed order) by the steps of clamping the first filament leg 102 to a first current supply wire 106 using the clamp 118 formed at a terminal end thereof; suspending the filament 100 within the cavity 112 using the first current supply wire 106; clamping the second filament leg 104 to the second current supply wire 108 using the clamp 116 formed at a terminal end thereof; adjusting the positions of the first and second current supply wires 106, 108 with respect to each other and the envelope 112 in which the cavity 114 is formed so that the coiled wire filament 100 is located in a predetermined position within the cavity 114; and sealing a portion of the second filament leg 104 and the terminal end of the second current supply wire 108 in the press seal 110 which is formed at end of the envelope and which closes one end of the cavity 114.

The disclosure of PCT publication WO 02/01601 published on Jan. 3, 2002 is hereby incorporated by reference thereto.

Even though the invention has been described with reference to only a limited number of embodiments, the various modification and changes which can be made without departing for the scope of the claims, which is limited only by the appended claims, will be self-evident to the person of skill in the art which the present invention pertains.

1. A single end halogen incandescent bulb comprising:
an envelope having a sealed cavity containing a halide material;
a press seal at one end of the envelope;
a coiled wire filament disposed in the sealed cavity;
first and second filament legs which respectively comprise portions of the coiled wire filament that have been drawn out straight so as to have a diameter which is approximately the same as a diameter of a wire comprising the first and second filament legs; and
first and second current supply wires;
the first current supply wire extending through the press seal into the sealed cavity, the first current supply wire having a first clamp formed at an end within the sealed cavity, the first clamp clamping the first filament leg to establish a first electrical connection and suspend the filament in the sealed cavity, and
the second current supply wire extending into and terminating in the press seal, the second current supply wire having a second clamp which clamps the second filament leg to establish a second electrical connection, the second clamp being enclosed in the press seal.

2. A single end halogen incandescent bulb as set forth in claim 1, wherein the first and second clamps are flat clamps wherein end portions of the first and second current supply wires are folded over and pressed flat against themselves.

3. A single end halogen incandescent bulb as set forth in claim 1, wherein the first and second filament legs extend in diametrically opposite directions.

4. A single end halogen incandescent bulb as set forth in claim 1, wherein the first current supply wire is longer than the second current supply wire and the first current supply wire extends through the sealed cavity along beside the coiled wire filament, an end portion of the first current supply wire having an angled portion which extends over the top of the filament and is provided with the first clamp.

5. A method of suspending a filament within a halogen containing cavity of a single end halogen incandescent bulb comprising:
drawing the ends of a coiled wire filament out straight to form first and second filament legs that respectively have diameters which are approximately the same as diameter of the wire from which the coiled filament is formed;
clamping a first filament leg to a first current supply wire using a clamp formed at a terminal end of the first current supply wire;
suspending the filament within the cavity using the first current supply wire;
clamping the second filament leg to the second current supply wire using a clamp formed at a terminal end of the second current supply wire;
adjusting the positions of the first and second current supply wires with respect to each other and an envelope in which the cavity is formed so that the coiled wire filament is located in a predetermined position within the cavity; and
sealing a portion of the second filament leg and the terminal end of the second current supply wire in a press seal which is formed at end of the envelope and which closes one end of the cavity.

6. A method as set forth in claim 5, further comprising arranging the first and second filament legs to extend in diametrically opposed directions.

7. A method as set forth in claim 6, wherein the step of clamping comprises using flat clamp members which are formed at the ends of the first and second current supply wires by folding end portions of the respective first and second current supply wires back against themselves.
